(19) United States
(12) Patent Application Publication
(10) Pub. No.: US 2012/0319945 A1
(43) Pub. Date: Dec. 20, 2012

(54) SYSTEM AND METHOD FOR REPORTING DATA IN A COMPUTER VISION SYSTEM

(76) Inventors: John McCarthy, Pleasanton, CA (US); Robert Campbell, Cupertino, CA (US); Bradley Neal Suggs, Sunnyvale, CA (US)

(21) Appl. No.: 13/581,944

(22) PCT Filed: May 21, 2010
(86) PCT No.: PCT/US10/35702

§ 371 Date: Aug. 30, 2012

(51) Int. Cl. G06F 3/01

(52) U.S. Cl. 345/156

(57) ABSTRACT

Embodiments of the present invention disclose a system and method for reporting data in a computer vision system. According to one embodiment, the presence of an object is detected within a display area of a display panel via at least one three-dimensional optical sensor. Measurement data associated with the object is received, and processor extracts at least one set of at least seven three-dimensional target coordinates from the measurement data. Furthermore, a control operation for the computer vision system is determined based on the at least one set of target coordinates.

### BACKGROUND

Providing efficient and intuitive interaction between a computer system and users thereof is essential for delivering an engaging and enjoyable user-experience. Today, most computer systems include a keyboard for allowing a user to manually input information into the computer system, and a mouse for selecting or highlighting items shown on an associated display unit. As computer systems have grown in popularity, however, alternate input and interaction systems have been developed. For example, touch-based, or touchscreen, computer systems allow a user to physically touch the display unit and have that touch registered as an input at the particular touch location, thereby enabling a user to interact physically with objects shown on the display. Due to certain limitations of conventional optical systems, however, a user's input or selection may be not be correctly or accurately registered by the present computing systems.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIGS. 1A and 1B are three-dimensional perspective views of a computer vision system according to an embodiment of the present invention.

FIG. 2 is a simplified block diagram of the computer vision system according to an embodiment of the present invention.

FIG. 3 depicts an exemplary three-dimensional optical sensor according to an embodiment of the invention.

FIG. 4A illustrates a top down perspective view of the computer vision system and an operating user thereof, while FIG. 4B is an exemplary graphical illustration of the target coordinates associated with the user of FIG. 4A according to an embodiment of the present invention.

FIG. 5A illustrates another top down perspective view of the computer vision system and an operating user thereof, while FIG. 5B is an exemplary graphical illustration of the target coordinates associated with the user of FIG. 5A according to one embodiment of the present invention.

FIG. 6 illustrates the processing steps for the reporting data in the computer vision system according to an embodiment of the present invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted to mean “including, but not limited to . . . ”. The term “couple” or “couples” is intended to mean either an indirect or direct connection. Thus, if a first component couples to a second component, that connection may be through a direct electrical connection, or through an indirect electrical connection via other components and connections, such as an optical electrical connection or wireless electrical connection. Furthermore, the term “system” refers to a collection of two or more hardware and/or software components, and may be used to refer to an electronic device or devices, or a sub-system thereof.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

For optimal performance, computer vision systems should be able to report data that is the right balance between rich details and easy computation. Generally, computer vision systems are configured to detect presence of a user within the field of view of a camera sensor. Still further, such systems may be configured to detect the location of body parts of the user within space around the system so as to facilitate a natural interaction between a person and a computer. Some systems report a user's hand as a ‘blob’ image, or may report a full set of skeletal points of the detected user. However, the data in such system is generally returned directly from the camera sensors and may include complete two-dimensional or three-dimensional video streams. These video streams are often quite large, causing processing delay and increasing the potential for processing errors.

Embodiments of the present invention provide a system and method of data reporting in a computer vision system that includes the location of only a small number of three-dimensional target coordinates of the arm and hand of a user. According to one embodiment, the target areas and coordinates represent only a portion of a detected user and may include the elbow of the user, a central area of the user's palm, and each finger tip of the user. Accordingly, the computer vision system utilizes only at least one set of seven target (x, y, z) coordinates for facilitating user interaction therewith, thus providing data that is meaningful, streamlined, and easy to consistently detect and use.

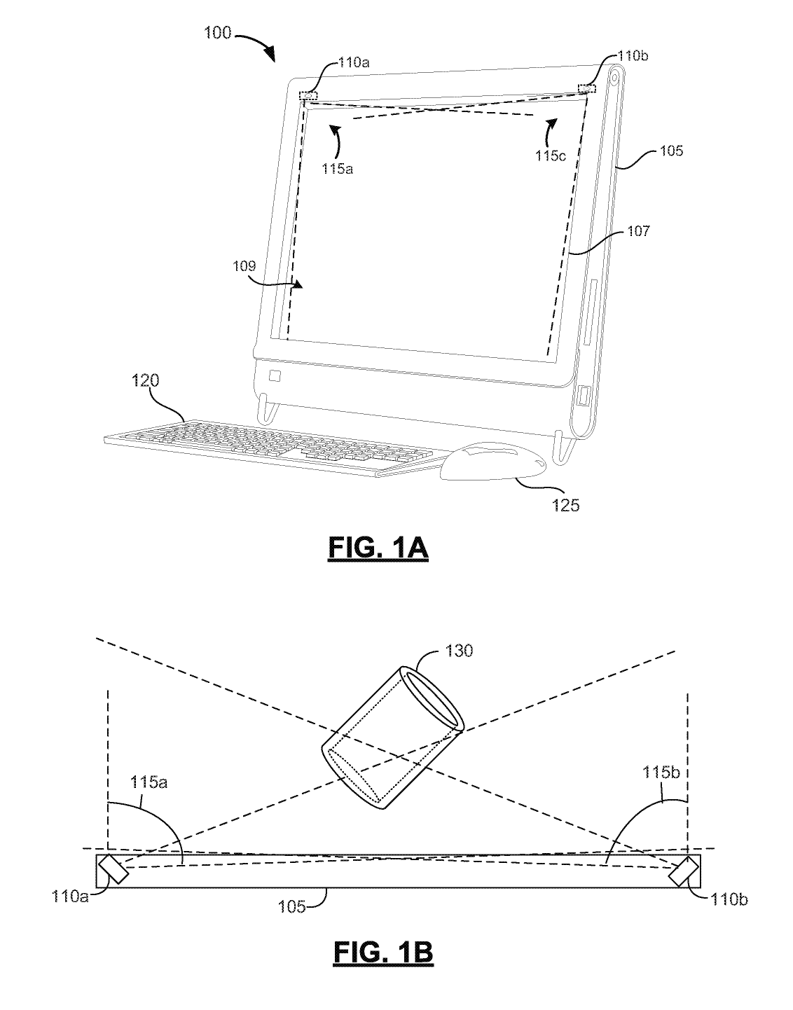

Referring now in more detail to the drawings in which like numerals identify corresponding parts throughout the views, FIG. 1A is a three-dimensional perspective view of an all-in-one computer having multiple optical sensors, while FIG. 1B is a top down view of a display device and optical sensors including the field of views thereof according to an embodiment of the present invention. As shown in FIG. 1A, the system 100 includes a housing 105 for enclosing a display panel 109 and two three-dimensional optical sensors 110a and 110b. The system also includes input devices such as a keyboard 120 and a mouse 125 for text entry, navigating the user interface, and manipulating data by a user for example.

The display system 100 includes a display panel 109 and a transparent layer 107 in front of the display panel 109. The front side of the display panel 109 is the surface that displays an image and the back of the panel 109 is opposite the front. The three dimensional optical sensors 110a and 110b can be on the same side of the transparent layer 107 as the display panel 109 to protect the three dimensional optical sensors from contaminates. In an alternative embodiment, the three dimensional optical sensors 110a and 110b may be in front of the transparent layer 107. The transparent layer 107 can be glass, plastic, or another transparent material. The display panel 109 may be a liquid crystal display (LCD) panel, a plasma display, a cathode ray tube (CRT), an OLED or a projection display such as digital light processing (DLP), for example. In one embodiment, mounting the three dimensional optical sensors 110a-110c in an area of the display system 100 that is outside of the perimeter of the of the display panel 109 provides that the clarity of the transparent layer is not reduced by the three dimensional optical sensors.

Three-dimensional optical sensors 110a and 110b are configured to report a three-dimensional depth map to a processor. The depth map changes over time as an object 130 moves in the respective field of view 115a of optical sensor 110a, or within the field of view 115b of optical sensor 115b. The three-dimensional optical sensors 110a and 110b can determine the depth of an object located within its respective field of view 115a and 115b. The depth of the object 130 can be used in one embodiment to determine if the object is in contact with the front side of the display panel 109. According to one embodiment, the depth of the object can be used to determine if the object is within a programmed distance of the display panel but not actually contacting the front side of the display panel. For example, the object 130 may be a user's hand and finger approaching the front side of the display panel 109. In one embodiment, optical sensors 110a and 110b are positioned at top most corners around the perimeter of the display panel 109 such that each field of view 115a and 115b includes the areas above and surrounding the display panel 109. As such, an object such as a user's hand for example, may be detected and any associated motions around the perimeter and in front of the computer system 100 can be accurately interpreted by the computer processor.

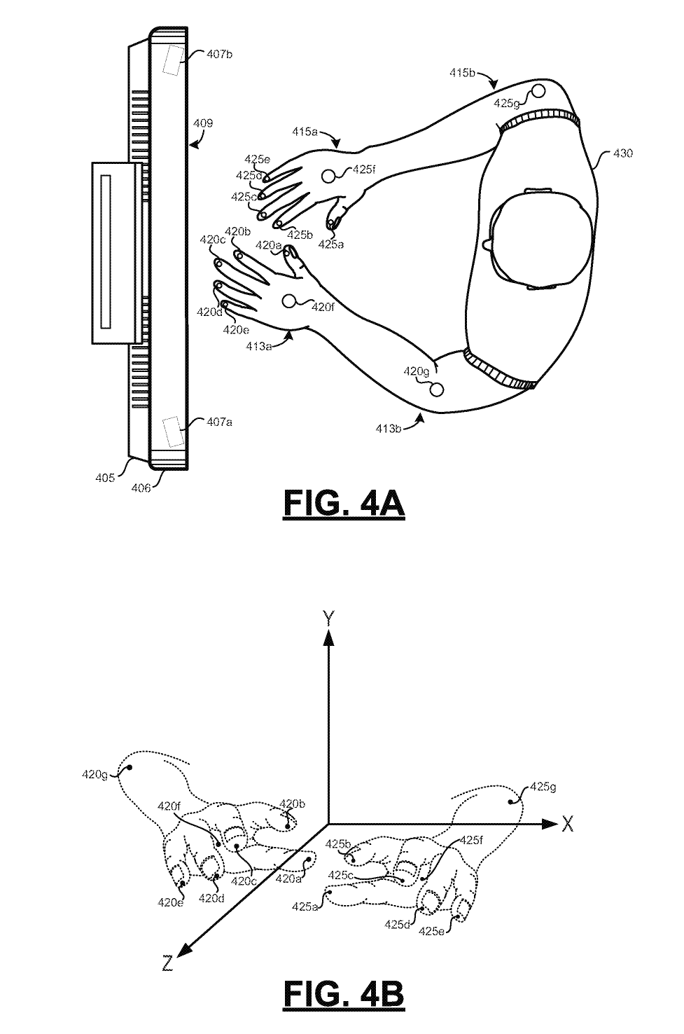

Furthermore, inclusion of three optical sensors 110a and 110b allows distances and depth to be measured from the viewpoint/perspective of each sensor (i.e. different field of views and perspectives), thus creating a stereoscopic view of the three-dimensional scene and allowing the system to accurately detect the presence and movement of objects or hand poses. For example, and as shown in the embodiment of FIG. 1B, the perspective created by the field of views 115a and 115b of optical sensors 110a and 110b respectively would enable detection of depth, height, width, and orientation of object 130 at its current inclined position with respect to a reference plane associated with each sensor 110a and 110b. Furthermore, a processor may analyze and store this data as measurement data to be associated with detected object 130. Accordingly, the differing field of views and differing perspectives of the optical sensors 110a and 110b work together to recreate a precise three-dimensional map and image of the detected object 130. Furthermore, the three-dimensional depth map and measurement data may be used to capture specific target points as will be described in further detail with reference to FIGS. 4A and 4B.

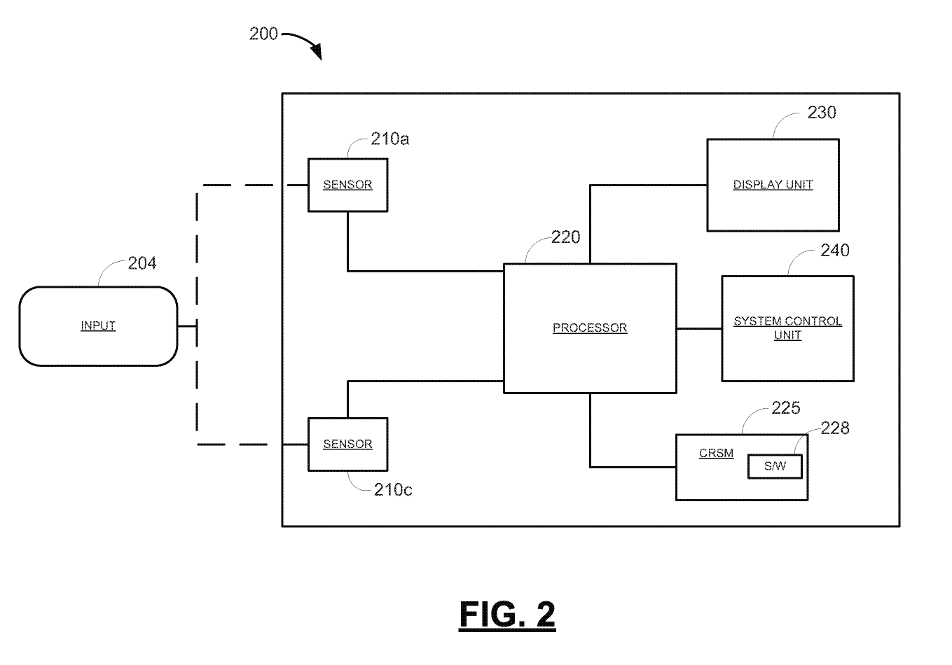

FIG. 2 is a simplified block diagram of the multi-camera system according to an embodiment of the present invention. As shown in this exemplary embodiment, the system 200 includes a processor 220 coupled to a display unit 230, a system control unit 240, a computer-readable storage medium 225, and three-dimensional optical sensors 210a and 210b configured to capture input 204, or measurement data related to an object in front of the display unit 230. In one embodiment, processor 220 represents a central processing unit configured to execute program instructions. Display unit 230 represents an electronic visual display or touch-sensitive display such as a desktop flat panel monitor configured to display images and a graphical user interface for enabling interaction between the user and the computer system. Storage medium 225 represents volatile storage (e.g. random access memory), non-volatile store (e.g. hard disk drive, read-only memory, compact disc read only memory, flash storage, etc.), or combinations thereof. In one embodiment, system control unit 240 may represent an application program or user interface control module configured to receive and process measurement data of a detected object. Furthermore, storage medium 225 includes software 228 that is executable by processor 220 and, that when executed, causes the processor 220 to perform some or all of the functionality described herein.

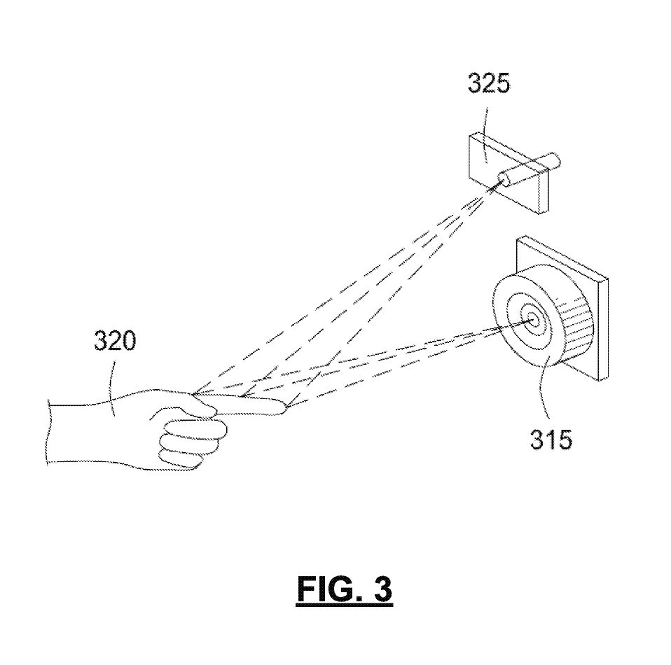

FIG. 3 depicts an exemplary three-dimensional optical sensor 315 according to an embodiment of the invention. The three-dimensional optical sensor 315 can receive light from a source 325 reflected from an object 320. The light source 325 may be an infrared light or a laser light source for example, that emits light and is invisible to the user. The light source 325 can be in any position relative to the three-dimensional optical sensor 315 that allows the light to reflect off the object 320 and be captured by the three-dimensional optical sensor 315. The infrared light can reflect from an object 320 that may be the user's hand in one embodiment, and is captured by the three-dimensional optical sensor 315. An object in a three-dimensional image is mapped to different planes giving a Z-order, order in distance, for each object. The Z-order can enable a computer program to distinguish the foreground objects from the background and can enable a computer program to determine the distance the object is from the display.

Conventional two-dimensional sensors that use a triangulation based methods may involve intensive image processing to approximate the depth of objects. Generally, two-dimensional image processing uses data from a sensor and processes the data to generate data that is normally not available from a two-dimensional sensor. Color and intensive image processing may not be used for a three-dimensional sensor because the data from the three-dimensional sensor includes depth data. For example, the image processing for a time of flight using a three-dimensional optical sensor may involve a simple table-lookup to map the sensor reading to the distance of an object from the display. The time of flight sensor determines the depth from the sensor of an object from the time that it takes for light to travel from a known source, reflect from an object and return to the three-dimensional optical sensor.

In an alternative embodiment, the light source can emit structured light that is the projection of a light pattern such as a plane, grid, or more complex shape at a known angle onto an object. The way that the light pattern deforms when striking surfaces allows vision systems to calculate the depth and surface information of the objects in the scene. Integral Imaging is a technique which provides a full parallax stereoscopic view. To record the information of an object, a micro lens array in conjunction with a high resolution optical sensor is used. Due to a different position of each micro lens with respect to the imaged object, multiple perspectives of the object can be imaged onto an optical sensor. The recorded image that contains elemental images from each micro lens can be electronically transferred and then reconstructed in image processing. In some embodiments the integral imaging lenses can have different focal lengths and the objects depth is determined based on if the object is in focus, a focus sensor, or out of focus, a defocus sensor. However, embodiments of the present invention are not limited to any particular type of three-dimensional optical sensor.

FIG. 4A illustrates a top down perspective view of the computer vision system and an operating user thereof, while FIG. 4B is an exemplary graphical illustration of the target coordinates associated with the user of FIG. 4A according to an embodiment of the present invention. As shown in FIG. 4A, the computer vision system includes a display housing 405, a display panel 406 and optical sensors 407a and 407b. The optical sensors 407a and 407b may be configured to detect a touchpoint, which represents a user input based on the user physically touching, or nearly touching (i.e. hover), the display panel 406 with their hand or other object. Here, the operating user places both arms 413 and 415 including hands 413a-415a and elbows 413b-415b within a display area on the front side 409 of the display panel 406. According to one embodiment, optical sensors 407a and 407b are configured to capture measurement data and generate a depth map of the user's arms 413 and 415. Once an accurate depth map of the detected object (i.e. user's arms) is available, the processor of the computer vision system is configured to extrapolate target points including fingertip points 420a-420e and 425a-425e of each hand 413a and 413b of the user 430, central palm points 420f and 425f of each hand 413a and 415a of the user 430, and central elbow points 420g and 425g associated with each elbow 413b and 415b of the user 430. Accordingly, a set of seven target points is determined for each arm 413 and 415 based on the generated depth map associated with the detected user 430.

FIG. 4B is an exemplary graphical illustration of the target coordinates associated with FIG. 4A according to one embodiment of the present invention. As shown here, the processor of the computer vision system reports two sets of seven (x, y, z) coordinates in a three-dimensional world coordinate system. For example, the system may report an (x, y, z) coordinate for each fingertip 420a-420e and 425a-425e, an (x, y, z) coordinate for each central palm area 420f and 420g, and an (x, y, z) coordinate for each central elbow area 420g and 425g. Therefore, the computer vision system of the present embodiment is configured to report a total of fourteen coordinates related to a detected hand and arm of a user within a display area of the a display panel. Furthermore, these coordinates are sufficient to provide accurate orientation and depth of the user's arm and hands with respect to the display panel. Accordingly, such target coordinates may be utilized by the processor and system control unit to determine an appropriate control operation for the computer vision system.

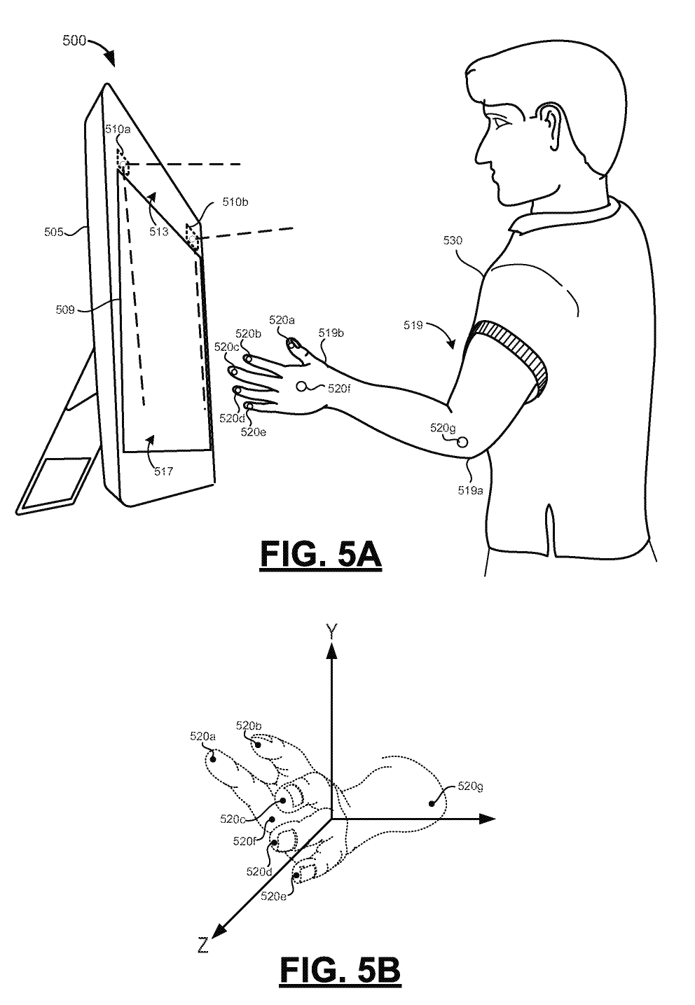

FIG. 5A illustrates another top down perspective view of the computer vision system and an operating user thereof, while FIG. 5B is an exemplary graphical illustration of the target coordinates associated with FIG. 5A according to one embodiment of the present invention. As shown here, the computer vision system includes a display housing 505, a display panel 509 and optical sensors 510a and 510b. In this exemplary embodiment, optical sensors 510a and 510b are formed near top corners of the display panel 509 along the upper perimeter side 513. Furthermore, optical sensors 510a and 510b are configured to have a field of view 515a and 515b respectively that faces in a direction that runs across the front surface side 517 of the display panel 509 and also projects outward therefrom. Still further, and in accordance with one embodiment, optical sensors 510a and 510b are configured to capture measurement data of a detected object (e.g. user 530) within a predetermined distance (e.g. one meter) of the front surface 517 of the display panel 509. In the present embodiment, the operating user places an arm 519 including elbow area 519a and hand 519b within a display area on the front side 517 of the display panel 509. As in the previous embodiment, an accurate depth map may be generated so as to allow the processor of the computer vision system to extrapolate a set of target points including fingertip points 520a-520e hand 519b, central palm point 520f of hand 519b, and central elbow point 520g of elbow area 519a. That is, the present embodiment illustrates an example of the computer vision system determining only a single set of seven target points when only one arm is utilized by the operating user 530 and accordingly detected by optical sensors 510a and 510b.

FIG. 5B is an exemplary graphical illustration of the target coordinates associated with FIG. 5A according to one embodiment of the present invention. As shown here, the processor of the computer vision system reports a single set of (x, y, z) coordinates in a three-dimensional world coordinate system. For example, the system may report an (x, y, z) coordinate for each fingertip 520a-520e, for central palm area 520f, and an (x, y, z) coordinate for central elbow area 520g. Therefore, the computer vision system of the present embodiment is configured to report at least seven coordinates related to a detected hand and arm of a user within a display area of a display panel. Like the previous embodiment, these seven coordinates are sufficient to provide accurate orientation and depth of a user's arm including the hand and elbow area with respect to the display panel. As such, such target coordinates may be utilized by the processor for determining an appropriate control operation for the computer vision system.

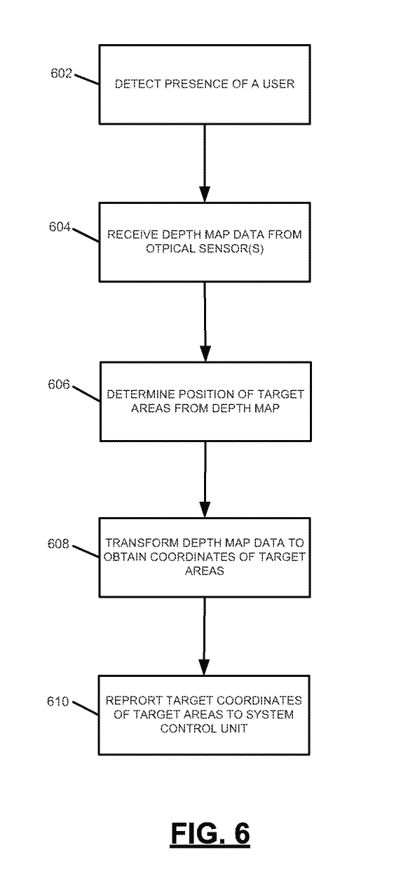

FIG. 6 illustrates the processing steps for the reporting data in the computer vision system according to an embodiment of the present invention. In step 602, the processor detects the presence of an object, such as a user's hand or stylus, within a display area of the display panel based on data received from at least one three-dimensional optical sensor. In one embodiment, the display area is any space in front of the display panel that is capable of being captured by, or within the field of view of, at least one optical sensor. In step 604, the processor receives from the at least one optical sensor that captures the object within its field of view, depth map data including measurement information of the object such as the depth, height, width, and orientation of the object for example. However, the measurement information may include additional information related to the object.

Thereafter, in step 606, the processor determines the position of target areas based on the received depth map data. For example, the processor determines a position of the user's arm including the elbow area and hand thereof, and also whether one or two arms are being used by the operating user. Next, in step 608, the processor utilizes to extrapolate at least one set of three-dimensional target coordinates including one (x, y, z) coordinate for each fingertip, central palm area, and elbow area of each detected arm as described in the previous embodiments. The target coordinates may be extrapolated using geometrical transformation of the associated depth map data, or any similar extrapolation technique. Then, in step 610, the processor may report the target coordinates to a system control unit for determining an appropriate control operation, or an executable instruction by the processor that performs a specific function on the computer system, based on the user's detected hand position and orientation. IN addition, the computer vision system of the present embodiments may be configured to detect movement of a user's hand (i.e. gesture) by analyzing movement of the target coordinates within a specific time period.

Embodiments of the present invention disclose a method of reporting the orientation and similar data of detected arms and hands in a computer vision system. Specifically, an embodiment of the present invention determines target areas and at least one set of three-dimensional target coordinates including the elbow of the user, a central area of the user's palm, and each finger tip of the user's hand. Furthermore, several advantages are afforded by the computer visions system in accordance with embodiments of the present invention. For example, the present embodiments provide a simplified and compact data set that enables for faster processing and reduced load time. As such, a user's desired input control can be detected more uniformly and consistently than conventional methods, thus achieving efficient and natural user interaction with the computer vision system.

Furthermore, while the invention has been described with respect to exemplary embodiments, one skilled in the art will recognize that numerous modifications are possible. For example, although exemplary embodiments depict an all-in-one computer as the representative display panel of the computer vision system, the invention is not limited thereto. For example, the computer vision system of the present embodiments may be implemented in a netbook, a tablet personal computer, a cell phone, or any other electronic device having a display panel and three-dimensional optical sensor.

Furthermore, although embodiments depict and describe a set including seven target coordinates for each detected arm, more than seven target coordinates may be used. For example, the user's central forearm area, central wrist, or knuckle position of each finger may be utilized and incorporated into the target coordinate set. That is, the above description includes numerous details set forth to provide an understanding of the present invention. However, it will be understood by those skilled in the art that the present invention may be practiced without these details. Thus, although the invention has been described with respect to exemplary embodiments, it will be appreciated that the invention is intended to cover all modifications and equivalents within the scope of the following claims.

What is claimed is:

1. A method for reporting data in a computer vision system including a display panel and processor, the method comprising:
detecting the presence of an object within a display area of a display panel via at least one three-dimensional optical sensor;
receiving, via the processor, measurement data associated with the object from the at least one optical sensor; and
extracting, via the processor, at least one set of at least seven target coordinates from the measurement data, wherein the target coordinates are (x, y, z) coordinates in a three-dimensional coordinate system and relate to only a portion of the detected object,
wherein a control operation for the computer vision system is determined based on the at least one set of target coordinates.

2. The method of claim 1, further comprising:
reporting, via the processor, the at least one set of seven target coordinates to a system control unit; and
determining, via the control unit, an appropriate control operation based on the received set of target coordinates.

3. The system of claim 1, wherein the object is a user's arm and hand positioned within a display area and field of view of at least one optical sensor.

4. The method of claim 3, wherein the step of extracting at least one set of target coordinates further comprises:
determining a quantity of sets of target coordinates to extract based on a quantity of arms and hands detected within the display area of the display panel.

5. The method of claim 4, wherein the set of seven target coordinates includes (x, y, z) coordinates for each of the user's fingertips, a central area of the user's palm, and a central area of the user's elbow.

6. The method of claim 4, wherein the control operation is an executable instruction by the processor that performs a specific function on the computer system.

7. The method of claim 1, wherein a plurality of optical sensors are arranged along an upper perimeter side of the display panel on opposite corners of the front side of the display panel.

8. A display system comprising:
a display panel including a perimeter and configured to display images on a front side; and
at least one three-dimensional optical sensor arranged around the perimeter of the display panel and configured to capture measurement data of an object within a field of view of the optical sensor,
a processor coupled to the at least one three-dimensional optical sensor and configured to extract at least one set of at least seven target coordinates from the measurement data, wherein the target coordinates are (x, y, z) coordinates in a three-dimensional coordinate system and relate to only a portion of the detected object, and
wherein only the at least one set of seven target coordinates are used for determining an appropriate control operation for the system.

9. The system of claim 8, further comprising:
a system control unit coupled to the processer and configured to receive the at least one set of seven target coordinates from the processor for determining the control operation.

10. The system of claim 8, wherein the object is a user's arm including a hand and elbow positioned within a display area and field of view of at least one optical sensor.

11. The system of claim 10, wherein the set of seven target coordinates includes (x, y, z) coordinates for each of the user's fingertips, a central area of the user's palm, and a central area of the user's elbow.

12. The system of claim 11, wherein the control operation is an executable instruction by the processor that performs a specific function on the computer system.

13. The system of claim 12, wherein at least two sets of target coordinates representing each of the user's arms and hands are returned to the processor for determining a control operation.

14. The system of claim 8, wherein a plurality of optical sensors are arranged along an upper perimeter side of the display panel on opposite corners of the front side of the display panel.

15. A computer readable storage medium having stored executable instructions, that when executed by a processor, causes the processor to:
detect the presence of an object within a display area of a display panel via at least one three-dimensional optical sensor;
receive measurement data from the at least one optical sensor; and
extract at least one set of seven target coordinates from the measurement data, wherein the target coordinates are (x, y, z) coordinates in a three-dimensional coordinate system and relate to only a portion of the detected object; and
determine a control operation based on only the at least one set of target coordinates.

16. The computer readable storage medium of claim 15, executable instructions to further cause the processor to:
report the at least one set of seven target coordinates to a system control unit; and
determine an appropriate control operation based on the received set of target coordinates.

17. The computer readable storage medium of claim 15, wherein the object is a user's arm and hand positioned within a display area and field of view of at least one optical sensor.

18. The computer readable storage medium of claim 17, wherein the step of extracting at least one set of seven target coordinates includes executable instructions to further cause the processor to:
determine a quantity of sets of target coordinates to extract based on a quantity of arms and hands detected within the display area of the display panel.

19. The computer readable storage medium of claim 18, wherein the set of seven target coordinates includes (x, y, z) coordinates for each of the user's fingertips, a central area of the user's palm, and a central area of the user's elbow.

20. The computer readable storage medium of claim 15, wherein the control operation is an executable instruction by the processor that performs a specific function on the computer system.
